(19) United States
(12) Patent Application Publication
(10) Pub. No.: US 2024/0133626 A1
(43) Pub. Date: Apr. 25, 2024

(54) FLAME PROTECTION APPARATUS FOR A BURNER, PLATE FIN FOR SUCH A FLAME PROTECTION APPARATUS AND DRYING DRUM COMPRISING SUCH A FLAME PROTECTION APPARATUS

(71) Applicant: Benninghoven Zweigniederlassung der Wirtgen Mineral Technologies GmbH, Wittlich (DE)

(72) Inventors: Jörg GENETSCH, Lieser (DE); Matthias Walter JOHANN, Bad Bertrich (DE); Ramón LICHT, Wittlich (DE); Stephan ZIMMER, Morbach (DE)

(21) Appl. No.: 18/489,127

(22) Filed: Oct. 17, 2023

(30) Foreign Application Priority Data
Oct. 19, 2022 (DE) 10 2022 211 106.0

(51) Int. Cl. F26B 11/02; E01C 19/05; F23M 9/00

(52) U.S. Cl. CPC F26B 11/028; E01C 19/05; F23M 9/00

(57) ABSTRACT

A flame protection apparatus for a burner, in particular in a drying drum, in particular in an asphalt facility, has a central longitudinal axis and a plurality of plate fins which are arranged in a circumferential arrangement in the circumferential direction with respect to the central longitudinal axis, wherein plate fins that are arranged adjacent to one another in the circumferential direction are sealed by means of a circumferential gap seal.

### CROSS-REFERENCES TO RELATED APPLICATIONS

This application claims the priority of German Patent Application, Serial No. DE 10 2022 211 106.0, filed Oct. 20, 2022, the content of which is incorporated herein by reference in its entirety as if fully set forth herein.

### FIELD

The disclosure relates to a flame protection apparatus for a burner, a plate fin for such a flame protection apparatus and a drying drum comprising such a flame protection apparatus.

### BACKGROUND

DE 10 2017 212 046 A1 discloses an installation for the manufacture of asphalt. A fire tube is arranged in a drying drum to protect the burner flame. In addition, a plate-fin recuperator is arranged in the drying drum as part of a flow guide unit, which is used for the targeted burning of pollutant components in the exhaust gas and/or in by-product gases.

### SUMMARY

It is an object of the disclosure to improve the burning process and, in particular, to reduce pollutant emissions.

The object is achieved by a flame protection apparatus for a burner, in particular in a drying drum, in particular in an asphalt facility, wherein the flame protection apparatus has a central longitudinal axis and a plurality of plate fins which are arranged in a circumferential arrangement in the circumferential direction with respect to the central longitudinal axis, wherein plate fins that are arranged adjacent to one another in the circumferential direction are sealed by means of a circumferential gap seal, by a plate fin for a flame protection apparatus and by a drying drum comprising a flame protection apparatus.

In a flame protection apparatus, plate fins that are arranged adjacent to each other in the circumferential direction can be arranged in a sealing manner relative to one another. A circumferential gap seal is formed between plate fins that are arranged adjacent to each other in the circumferential direction. This means that a gap is formed between the adjacent plate fins, which gap decreases and in particular closes during the operation of the flame protection apparatus as a result of a thermal expansion of the plate fins. This is based on the finding that during the operation of the drying drum, temperatures in a range of 300° C. to 700° C., in particular in a range of 350° C. to 650° C., in particular in a range of 380° C. to 620° C. and in particular in a range of 400° C. to 600° C. are present at the flame protection apparatus.

The circumferential gap seal, also known as a labyrinth seal, is in particular a noncontact seal. The sealing effect is based on the extension of the flow path through the gap to be sealed, whereby a flow resistance is substantially increased. The extension of the path is achieved in particular by interlocking shaped elements of the adjacent plate fins. In a plane perpendicular to the central longitudinal axis of the flame protection apparatus, the circumferential gap seal has a non-linear form and is in particular designed in a curved manner at least in sections. In particular, the circumferential gap seal is designed S-shaped in the plane oriented perpendicular to the central longitudinal axis.

Additionally or alternatively, the shaped elements laterally to the gap can lead to turbulences of a gas flow in the flame protection apparatus, so that a higher sealing effect is achieved as a result.

In the cold state, the gap width of the circumferential gap seal is at most 5 mm, in particular at most 4.5 mm and in particular at most 4 mm. In relation to the sheet thickness of the plate fins, the gap width in the cold state is in particular at most 100%, in particular at most 90% and in particular at most 80%. In particular, the gap is designed such that it reaches a minimum gap width when the operating temperature is reached. The minimum gap width is in particular at most 1.0 mm, in particular at most 0.8 mm, in particular at most 0.5 mm, in particular at most 0.3 mm and in particular at most 0.1 mm. In relation to the sheet thickness of the plate fin, the minimum gap width when the operating temperature is reached is at most 20%, in particular at most 15%, in particular at most 10%, in particular at most 5% and in particular at most 2%.

The gap can also be designed in such a manner that when the operating temperature is reached, the thermal expansion of the plate fins causes the adjacent plate fins to come into contact with each other at least in some regions, i.e. the gap is at least partially closed.

The plate fins are made of a heat-resistant material, in particular an austenitic chromium-nickel steel, in particular with the material number 1.4841 according to DIN EN 10095. This material has a thermal expansion coefficient α in the relevant temperature range of between 15×10⁻⁶ and 20×10⁻⁶, in particular between 17×10⁻⁶ and 18×10⁻⁶. The dimensioning of the gap for the circumferential gap seal is also carried out in particular in dependence on the material used for the plate fins. Other chromium-nickel steels are also possible, in particular 1.4828 or 1.4742, which is known under the trade name Sicromal 10.

With the flame protection apparatus, the thermal conditions and in particular the gas flow conditions are improved during a combustion process. Thermally heated air is reliably kept inside the flame protection apparatus and cannot escape even through gaps between the plate fins. The burning process is more efficient. Heat losses are reduced. Due to the fact that the plate fins seal each other, it is prevented that material to be dried falls unintentionally into the flame. Disturbances of the flame, which could lead to a reduction in the efficiency of the burning process, are reliably excluded. The flame protection apparatus enables more efficient burning. The emission of undesirable exhaust gases, in particular the proportion of unburned hydrocarbons (C_{gas}), in particular carbon monoxide (CO) and/or carbon dioxide (CO₂) is reduced. The method is ecologically and economically improved. The burning process is more sustainable.

The plate fins are arranged in particular parallel to the central longitudinal axis of the flame protection apparatus.

The flame protection apparatus is used for a burner with which, in particular, an open burner flame is produced. The burner can be operated with fossil fuels, in particular fossil energy sources such as natural gas, liquid gas, fuel oil and/or coal dust. Additionally or alternatively, the burner can be operated with renewable fuels such as wood pellets, wood dust, methane produced from biogas and/or hydrogen gas.

The burner serves in particular to heat a drying drum, which is used in particular to heat material in an asphalt facility. The flame protection apparatus in such a drying drum enables an increased addition of recycled material, i.e. in particular old asphalt granulate. The production of asphalt is thus more sustainable, as the use of raw materials is reduced.

The flame protection apparatus ensures uncomplicated and robust installation in the drying drum. In particular, it is dispensable to provide a fire tube on the one hand and a plate-fin recuperator on the other hand. The flame protection apparatus enables functional integration. The number of installed components is reduced. The flame protection apparatus is designed to be unsophisticated and cost-efficient.

In particular, it has been recognized that it is not necessary for the plate fins to be designed to overlap in the circumferential direction and/or axially. In particular, the manufacture of the plate fins and in particular their arrangement to form a flame protection apparatus is simplified.

A flame protection apparatus in which plate fins that are arranged adjacent to one another in the circumferential direction have sealing elements that face one another, in particular sealing strips, enables an uncomplicated and efficient design of the gap seal. The adjacent plate fins each have sealing elements which correspond to one another. In particular, the sealing elements are arranged laterally on the plate fins. In particular, the sealing elements extend in a direction which is oriented parallel to the central longitudinal axis. The sealing elements are in particular configured as sealing strips. The sealing elements are in particular part of the circumferential gap seal. In particular, the sealing elements are designed such that an outer contour of one sealing element corresponds with an inner contour of the other sealing element.

A flame protection apparatus in which the sealing elements are formed in one piece and are designed in particular as folded edges of the plate fins enables an uncomplicated and efficient design of the sealing elements on the plate fins. The manufacture of the plate fins with the sealing elements is simplified. The sealing elements are in particular designed as folded edges. The sealing elements can extend along the entire length of the plate fins. The sealing elements can be configured to be discontinuous at least in sections, in particular in order to simplify the manufacture of the sealing elements. The plate fins have an increased stiffness. The risk of undesired deformation of the plate fins due to thermal stress is reduced and in particular excluded.

Alternatively, it is conceivable to fasten the sealing elements, in particular as preshaped, in particular strip-like shaped elements, to the plate fins, in particular to weld them on and/or to fasten them detachably, in particular to screw them on.

Plate fins which have a flame protection section that faces the central longitudinal axis and is configured to be flat are particularly uncomplicated to manufacture. The plate fins each have a flame protection section, which is in particular of rectangular design. The sealing elements in particular adjoin the flame protection section laterally. The plate fins can be produced from a sheet metal blank and in particular by forming the folded edges.

A flame protection apparatus in which the circumferential arrangement of the plate fins is configured to be self-supporting has static advantages, in particular when the flame protection apparatus is mounted. Fastening of the flame protection apparatus, for example in a drying drum, is simplified. In particular, it has been recognized that the circumferential gap seal simplifies the self-supporting function of the circumferential arrangement. Due to the fact that adjacently arranged plate fins on the circumferential gap seal engage behind each other at least in sections and in particular in a linear manner, in particular in the radial direction, in particular alternating in the circumferential direction, no additional shaped elements are required.

A plate fin holder comprising at least one plate fin holder which is fastened to a plate fin ensures a simplified assembly. In particular, the plate fins are placed on and/or attached to the plate fin holder. In particular, the plate fins are detachably fastened to the plate fin holder. Due to the advantageous fastening of the plate fin holder to the plate fin, a maximum deformation of the plate fin as a result of thermal expansion is reduced. In particular, the deformation of the plate fin is reduced by more than half with respect to a plate fin according to DE 10 2017 212 046 A1, and in particular to at most 40% of the deformation of such a plate fin. In particular, there are several plate fin holders per plate fin, in particular precisely two plate fin holders per plate fin.

Alternatively, it is possible to connect the plate fins firmly and in particular non-detachably to the corresponding plate fin holders, in particular the plate fin holders are welded to the plate fins. It is advantageous if the contact surface between the plate fin holder and the plate fin is minimized. In particular, the end face of the plate fin holder is arranged on the outside of the plate fin. An essentially linear contact surface is formed between the plate fin holder and the plate fin, which surface is oriented in particular in the circumferential direction and in particular perpendicularly to the central longitudinal axis.

For the assembly of the flame protection apparatus, it is advantageous if the individual plate fins are attached to the respective plate fin holders one after the other in the circumferential direction. In particular, the plate fins are placed on the plate fin holders. Recesses, in particular punched holes, can be provided on the outer sides of the plate fins for positional fixing. The plate fin holders can engage in the recesses or punched holes with corresponding projections. To complete the circumferential arrangement, the last plate fin of the circumferential arrangement is inserted axially between two adjacent plate fins. The plate fin inserted in this manner is also referred to as the end plate fin. The end plate fin is held by an end plate fin holder, which is structurally different from the other plate fin holders. The end plate fin holder does not have any radially protruding projections that are attached to the end face of the plate fin holder and engage in the corresponding recesses and/or apertures. Instead, the plate fin holder has a curved supporting section at which the end plate fins are connected to the end plate fin holder, in particular welded, in particular by means of plug welding.

A flame protection apparatus in which a plurality of circumferential arrangements are arranged one behind the other along the central longitudinal axis, wherein an axial gap seal is formed in particular between plate fins which are arranged adjacent to one another along the central longitudinal axis, is of modular design. In particular, it is possible for the individual plate fins to be of small construction and adapted in length to the production method. The axial extension of the flame protection apparatus can be extended in an uncomplicated manner by means of multiple circumferential arrangements in succession. The flame protection apparatus can be easily adapted to the expected length of the burner flame.

In particular, an axial gap seal can be formed between circumferential arrangements that are arranged one behind the other.

Plate fins which have a folded edge at a transverse, in particular perpendicular, orientation with respect to the central longitudinal axis enable an uncomplicated design of the axial gap seal.

A folded edge that is oriented transversely to the central longitudinal axis enables an advantageous implementation of the axial gap seal. The plate fin is additionally stabilized and has an increased rigidity.

A plate fin for a flame protection apparatus enables the advantages of the flame protection apparatus itself.

A drying drum comprising a flame protection apparatus enables the burning process to be advantageously performed with increased efficiency and/or reduced exhaust gas emission. In particular, the drying drum enables the use of increased proportions of old asphalt granulate in asphalt production.

Both the features set forth above and the features specified in the following embodiment examples of the flame protection apparatus are each suitable, either on their own or in combination with one another, for further embodiment of the subject-matter according to the disclosure. The respective combinations of features do not constitute any restriction with regard to the further embodiments of the subject-matter of the disclosure, but are essentially merely exemplary in character.

Further advantageous embodiments, additional features and details of the disclosure will be apparent from the following description of an embodiment example based on the drawing, in which:

### BRIEF DESCRIPTION OF THE DRAWINGS

FIG. 1 shows a schematic sectional view of an arrangement with a burner attached to a drying drum and a flame protection apparatus arranged in the drying drum,

FIG. 2 shows a longitudinal section through the drying drum according to FIG. 1,

FIG. 3 shows a view of the drying drum according to arrow III in FIG. 1,

FIG. 4 shows an enlarged partial sectional illustration according to section line V-V in FIG. 2,

FIG. 5 shows a perspective view of a front end of the drying drum according to FIG. 2,

FIG. 6 shows an enlarged detail view of detail VI in FIG. 5

FIG. 7 shows a different view of the drying drum according to FIG. 5,

FIG. 8 shows an enlarged detail view of detail VIII in FIG. 7,

FIG. 9 shows a perspective individual view of a plate fin according to FIG. 8.

### DETAILED DESCRIPTION

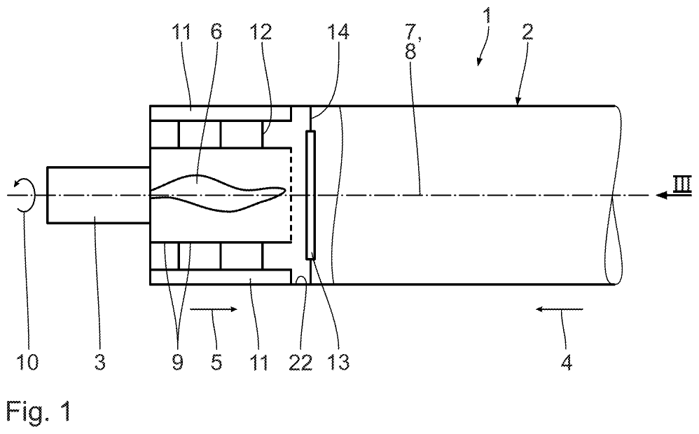

An arrangement designated as a whole as 1 in FIG. 1 comprises a drying drum 2, on the end face of which a burner 3 is arranged. The arrangement 1 is in particular part of an asphalt facility in which asphalt material is produced.

In the drying drum 2, in particular white mineral is heated in a countercurrent process. This means that a material flow direction 4 and a heat propagation direction 5 are oriented opposite to each other. The drying drum 2 can also be operated in a co-current process. In particular, other materials, in particular rock and/or old asphalt material, can also be heated in the drying drum 2.

The burner 3 generates a burner flame 6 which projects at least partially into the drying drum 2.

A flame protection apparatus is arranged in the drying drum 2, in particular in the region of the burner flame 6. The flame protection apparatus has a central longitudinal axis 7 which coincides with an axis of rotation 8 of the drying drum 2.

The flame protection apparatus has a plurality of plate fins 9 arranged in the circumferential direction 10 with respect to the central longitudinal axis 7. The plate fins 9 ensure that thermally heated air remains within the circumferential arrangement 10 and does not unintentionally flow outwards, in particular in a radial direction with respect to the central longitudinal axis 7. The plate fins 9 prevent material heated in the drying drum 2 from unintentionally falling into the burner flame 6 and thus adversely affecting the burning process.

The flame protection apparatus has lifter plates 11. The lifter plates 11 are arranged concentrically with respect to the central longitudinal axis 7, in particular with respect to the plate fins 9 in the drying drum 2. The lifter plates 11 are arranged in the flame region of the drying drum 2. During a rotation of the drying drum 2, the lifter plates 11 enable the material to be dried to be carried along, i.e. material conveyance along the material conveying direction 4. The lifter plates 11 are configured in particular in such a manner that a material veil is prevented in the drying drum 2 when the material is carried along. This means that the material is held in a radial direction in the lifter plates 11 when the drying drum 2 rotates about the axis of rotation 8 and, in particular, material is conveyed exclusively axially along the material conveying direction 4. In particular, by means of the lifter plates 11, it is reliably prevented that the material trickles from top to bottom in the drying drum 2 due to the force of gravity and forms a material veil.

By entraining the material in the lifter plates 11, both the lifter plates 11 themselves and the drying drum 2 are thermally protected from the burner flame 6 and/or the heat radiation emitted by the burner flame 6. As a result, the material cools the fixtures and the drying drum 2.

Plate fin holders 12 are attached to the lifter plates 11 and serve to hold the plate fins 9. The plate fin holders 12 are attached to the lifter plates 11. The plate fin holders 12 extend in particular perpendicularly to the central longitudinal axis 7 and in particular radially.

The flame protection apparatus has a baffle plate 13. The baffle plate 13 is arranged along the central longitudinal axis 7 at an axial distance from the plate fins 9. The baffle plate 13 is disc-like and, in particular, essentially circular in shape and is fastened in the drying drum 2 by at least one baffle plate fastening element 14. The baffle plate 13 prevents the burner flame 6 from unintentionally striking through into a further baffle plate region of the drying drum 2 that is arranged behind the baffle plate 13. A material veil is deliberately produced in this additional baffle plate region. The baffle plate 13 prevents damage to the material.

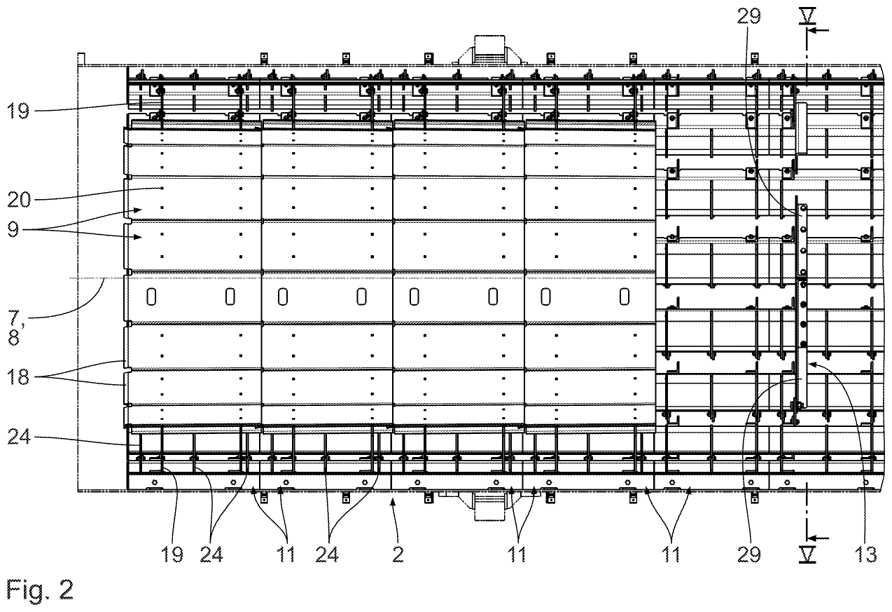

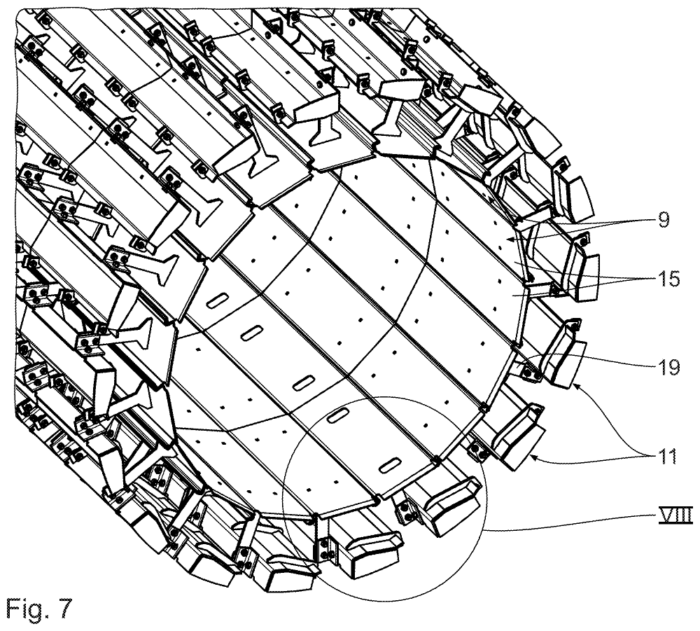

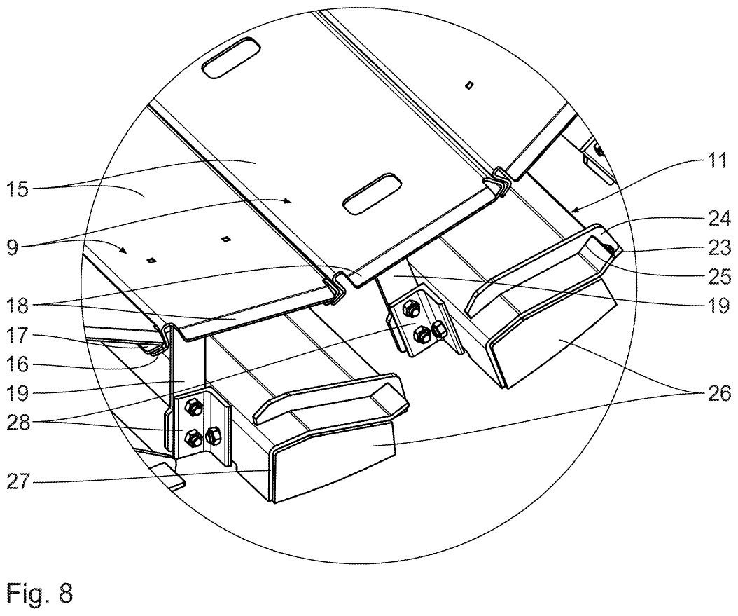

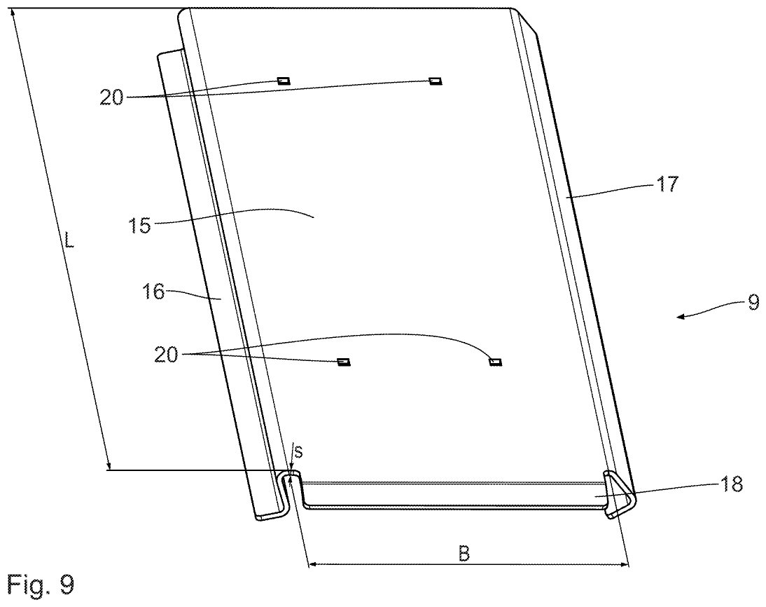

The flame protection apparatus is explained in more detail below with reference to FIG. 2 to FIG. 9.

A circumferential arrangement of the plate fins 9 comprises eighteen individual plate fins 9. The plate fins 9 are configured to be functionally identical and in particular have identical dimensions. Depending on the size to be formed, i.e. the clear width of the circumferential arrangement, more or less than eighteen plate fins 9 may also be used to form a circumferential arrangement.

Along the central longitudinal axis 7, four circumferential arrangements are arranged one behind the other according to the embodiment example shown. More or less than four circumferential arrangements may also be arranged one behind the other. The individual circumferential arrangements are in particular of identical design. It is also conceivable that the circumferential arrangements have different diameters and/or are configured conically at least in sections.

The plate fins 9 each have a flame protection section 15 facing inwards, i.e. towards the burner flame 6. The flame protection section 15 has a rectangular contour with a length L and a width B. According to the embodiment example shown, the length L of the plate fin 9 is greater than its width B. In particular, L>=1.2×B, in particular L>=1.5×B, in particular L>=2.0×B, in particular L>=2.5×B and in particular L<=10×B. The plate fins 9 are arranged side by side in the circumferential arrangement with respect to their longitudinal direction. In the circumferential arrangement, the plate fins 9 are oriented with their longitudinal direction parallel to the central longitudinal axis 7. This means that a contour formed by the plate fins 9 in a plane perpendicular to the central longitudinal axis 7 is constant along the central longitudinal axis 7. Due to the fact that the flame protection sections 15 are designed to be flat, the circumferential arrangement has an inner contour in a plane perpendicular to the central longitudinal axis 7, which inner contour is essentially polygonal in shape.

The plate fins 9 are made from the material with the number 1.4841 from a sheet metal blank. The sheet thickness s is in particular in a range of 3 mm to 10 mm and in particular between 5 mm and 7 mm.

The plate fin 9 has sealing elements 16, 17 that are formed in one piece on its longitudinal edges. The sealing elements 16, 17 are configured as folded edges. The sealing elements 16, 17 are configured to correspond to each other. The sealing elements 16, 17 form lateral sealing elements on the plate fins 9. The sealing elements 16, 17 form sealing strips. The sealing elements 16, 17 are designed so that the plate fins 9 are arranged alternately with the sealing elements 16, 17 in the circumferential order.

A first sealing element 16 has essentially an S contour. The S-contour extends in particular from the flame protection section 15 in a direction facing away from the burner flame 6. The first sealing element 16 forms a concave receptacle.

The second sealing element 17 has a contour which corresponds to a rounded arrowhead. The second sealing element 17 forms a convexly shaped projection.

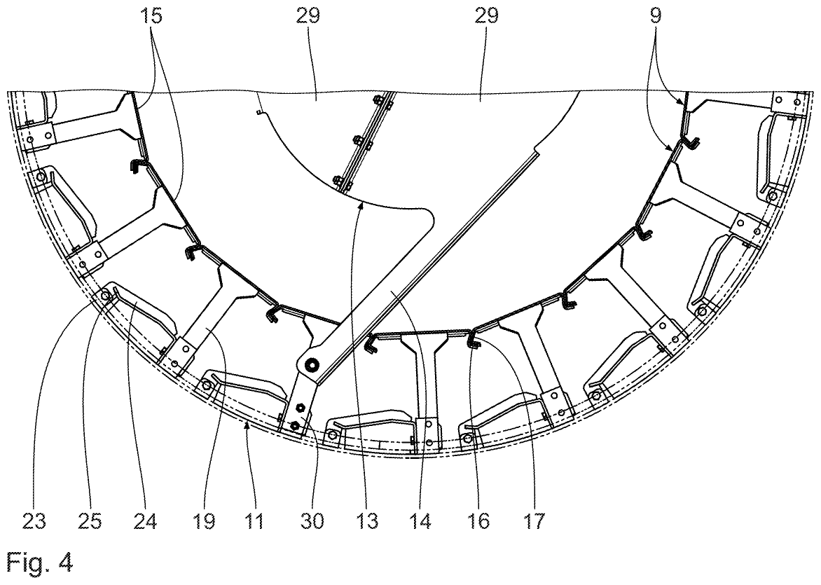

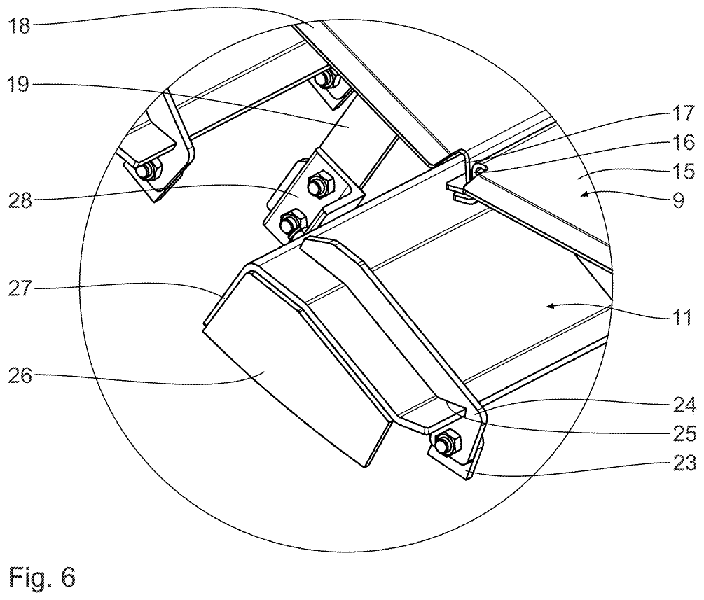

The convex outer contour of the second sealing element 17 corresponds to the concave inner contour of the first sealing element 16. In particular, the second sealing element 17 of a plate fin 9 can be arranged at the first sealing element 16 of an adjacent plate fin 9. This arrangement of adjacent plate fins 9 with the sealing elements 16, 17 arranged one inside the other is shown in particular in FIGS. 4 and 6. Corresponding sealing elements 16, 17 of adjacent plate fins 9 interlock with each other so that at most a thin air gap remains which is at any rate smaller than the sheet thickness s of the plate fins 9. In particular, the maximum gap width is at most 0.5×s, in particular at most 0.3×s, in particular at most 0.2×s and in particular 0.1×s.

Due to this thin gap between the adjacent plate fins 9, a circumferential gap seal is formed. As a result of the thermal expansion of the plate fins 9 during the operation of the drying drum 2, the gap width continues to decrease.

Due to the fact that the plate fins 9 of a circumferential arrangement interlock with the respective adjacent sealing elements 16, 17, the circumferential arrangement is configured to be self-supporting. It is prevented that the plate fins 9 detach from each other unintentionally. The sealing elements 16, 17 engage behind the adjacent plate fins 9 such that the circumferential arrangement is stable in the radial direction with respect to the central longitudinal axis 7.

At a transverse edge which is oriented in the width direction, the plate fins 9 have a front folded edge 18. The front folded edge 18 is inclined downwards by an angle of inclination with respect to the plane formed by the flame protection section 15. This angle of inclination is at most 30°, in particular at most 20°, in particular at most 15° and in particular at most 10°. The folded edge 18 acts as an insertion tab which can be inserted in particular into the respective circumferential arrangement that is arranged upstream thereof.

If multiple circumferential arrangements are arranged one behind the other along the central longitudinal axis 7, the plate fins 9 of the respective rear circumferential arrangement are pushed with the folded edge 18 under the respective plate fin 9 of the circumferential arrangement arranged upstream. This means that the folded edge 18 is arranged on the inside of the circumferential arrangement facing the burner flame 6. The folded edge 18 forms an axial gap seal between the circumferential arrangements that are arranged one behind the other along the central longitudinal axis 7. The tightness of the circumferential arrangements is high.

The plate fins 9 arranged one behind the other along the central longitudinal axis 7 are arranged in alignment.

Each plate fin 9 is held by at least one plate fin holder 19 and, according to the embodiment example shown, by two plate fin holders 19. The plate fin holder 19 is made from a flat sheet metal blank and in particular has a strip-like contour. The plate fin holder 19 is in particular made of the same material as the plate fin 9. The sheet thickness of the plate fin holder is in particular between 8 mm and 15 mm and in particular between 10 mm and 12 mm.

According to the embodiment example shown, the plate fin holder 19 has projections, in particular two holding pins, which are arranged in particular on the front side. The holding pins can engage in recesses 20 which are arranged at the flame protection section 15. The recesses 20 are in particular configured as punched holes. The plate fin 9 is in particular supported or placed on the plate fin holder 19. The recesses 20 serve as a mounting aid for the plate fin holder 19 of the plate fin 9. In particular, the plate fin 9 is detachably fastened to the plate fin holder 19. This simplifies the assembly of the circumferential arrangement. In addition or alternatively, the plate fin holders 19 can also be non-detachably fastened to the plate fin 9, in particular welded on.

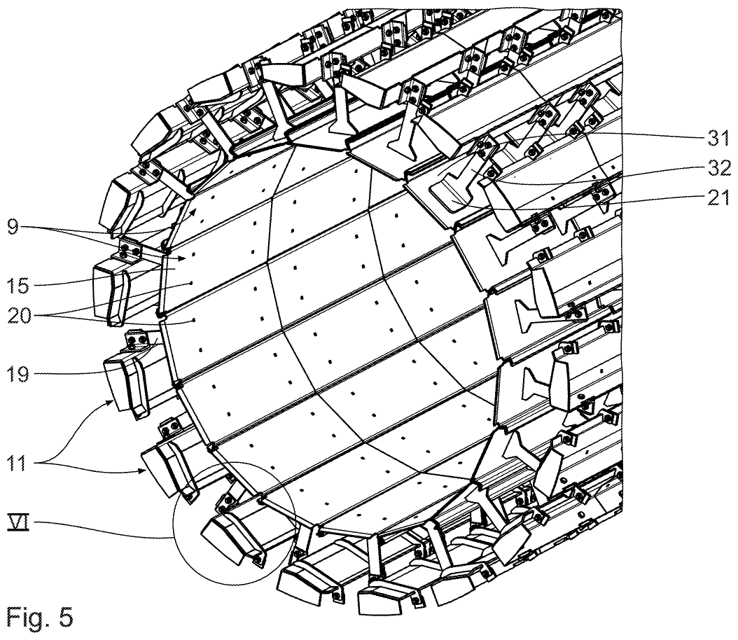

In each case, at least one plate fin 31 per circumferential arrangement is designed differently with respect to the recesses 20. This plate fin is referred to as the end plate fin 31. Accordingly, the associated end plate fin holders 32 for the end plate fin 31 do not have any protruding holding pins, but rather a bent-over supporting tab 21, which is shown in particular in FIG. 5.

The circumferential arrangement is formed by arranging plate fins 9 adjacent to one another in sequence in the circumferential direction 10 and placing them on the respective plate fin holders 19. The plate fins 19 are stabilized by the interlocking sealing elements 16, 17 on the one hand and by the engagement of the holding pins in the recesses 20 on the other hand. The last plate fin 31 is inserted axially, i.e. in a direction parallel to the central longitudinal axis 7, and engages with the two adjacent plate fins 9. The sealing elements 16, 17 ensure an undercut in the radial direction between adjacent plate fins 9 or 9, 31. The last mounted plate fin 31 is fastened, in particular welded, to the supporting tabs 21.

By using the plate fin holders 19, it is possible for the plate fins 9 to be arranged in the drying drum 2 at a radial distance with respect to an inner wall 22 of the drying drum 2. The plate fins 9 form an installation that is spaced from the inner wall 22 and aligned concentrically with respect to the central longitudinal axis 7. The circumferential arrangement is substantially ring-shaped with the polygonal inner contour. The circumferential arrangement is fixedly connected to the drying drum 2. When the drying drum 2 rotates, the circumferential arrangement rotates with it.

With respect to the plate fins 9, the lifter plates 11 are arranged so as to be offset radially outwards with respect to the axis of rotation 8. In particular, the lifter plates 11 are arranged on the inner wall 22 of the drying drum 2.

For this purpose, holding tabs 23 can be fastened directly to the inner wall 22, in particular welded thereto. A fastening strip 24 is detachably fastened, in particular screwed, to each of the holding tabs 23. In particular, each lifter plate 11 is held by several, in particular three, fastening strips 24, wherein the fastening strips 24 are configured to be identical and are arranged at a distance from one another along the central longitudinal axis 7.

The fastening strips 24 each have a slot-shaped receptacle 25 into which the lifter plates 11 are inserted.

The lifter plate 11 is designed to be vane-like and has an L-shaped contour in a plane that is oriented perpendicularly with respect to the central longitudinal axis 7. The lifter plate 11 is arranged on the inner wall 22 of the drying drum 2 such that the short web of the “L” extends essentially parallel to the inner wall 22 of the drying drum 2. Essentially means that the lifter plate 11 has no curvature on the inner wall 22 of the drying drum 2. To increase stiffness, the lifter plate 11 can be designed with folded edges. A material receiving chamber is formed between the lifter plate 11 and the inner wall 22 of the drying drum 2, which has an open rectangular contour in a plane perpendicular to the central longitudinal axis 7. The rectangle is open on a side opposite the short web of the “L”. In particular, the material receiving chamber is also open along the central longitudinal axis 7. It is possible that these end faces of the material receiving chamber are closed by separate lid elements 26. In particular, the end face of the material receiving chamber that faces the material outlet of the drying drum 2 is closed by the lid element 26. The lid element 26 is fastened, in particular welded, to the lifter plate 11.

The lifter plates 11 arranged one behind the other along the central longitudinal axis 7 are thus arranged continuously relative to one another, i.e. abutting one another at the end faces. The material receiving channel that extends over several lifter plates 11 is formed by the lifter plates 11.

The design of the lifter plates 11 ensures that the material to be heated is reliably carried along in the drying drum 2, but that no material veil is formed in the region of the plates 9.

The short web of the “L” forms a rear wall 27 of the lifter plate 11. The plate fin holders 19 of the plate fins 9 are detachably fastened to the rear wall 27. According to the embodiment example shown, a holding angled bracket 28 in particular serves for this purpose, which bracket 28 is designed in particular as an L-profile and enables the sheet metal sections that are oriented at 90° to each other to be screwed together.

It is particularly advantageous that the plate fin holders 19 are detachably fastened to the lifter plates 11. Retrofitting the plate fin holders 19 and/or the plate fins 9 held thereon is simplified. In particular, it is not necessary for the plate fins 9 to be fastened to the inner wall itself by means of the plate fin holders 19. The mounting effort and dismounting effort are reduced.

In particular, at least one lifter plate 11 is provided for each plate fin 9. Corresponding plate fins 9 and lifter plates 11 are arranged in alignment in the radial direction with respect to the central longitudinal axis 7.

According to the embodiment example shown, in addition to the four lifter plate arrangements, which are arranged concentrically to the respective circumferential arrangements of the plate fins 9, two further rows of lifter plates 11 are provided. No plate fins 9 are fastened to these lifter plates 11. These lifter plates are thus arranged in an exposed position.

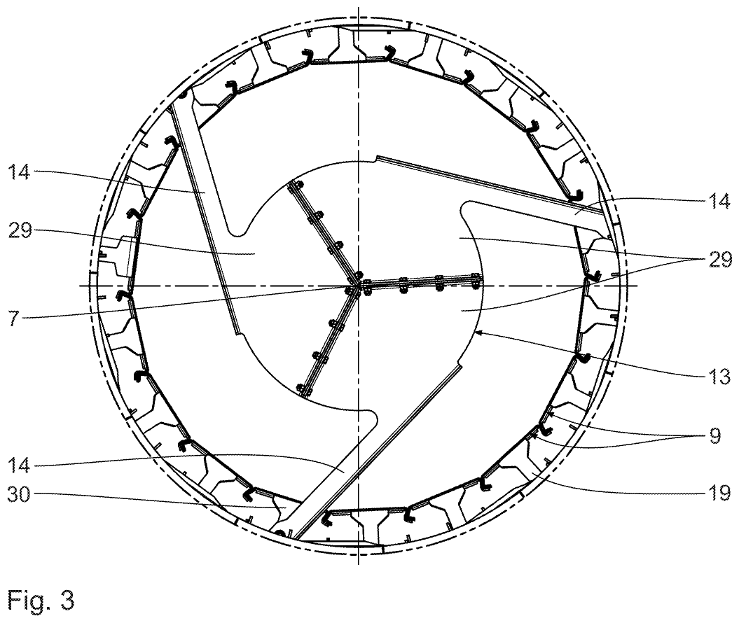

Axially spaced from the plate fins 9 there is the baffle plate 13, which is shown in particular in FIG. 3. The baffle plate 13 is configured from several, according to the embodiment example shown three, identical baffle plate segments 29. The baffle plate segments 29 each have a disc section and a baffle plate fastening element 14 that is attached thereto in one piece. The disc sections are each configured according to a one-third circular disc, i.e. with an opening angle of 120° with respect to the central longitudinal axis 7. To connect the baffle plate segments 29, flange strips are folded on the baffle plate segments 29 and screwed together. The baffle plate segments 29 are attached to corresponding lifter plates 11 by means of the baffle plate fastening elements 14 and a holding tab 30 provided for this purpose.

What is claimed is:

1. A flame protection apparatus for a burner, the flame protection apparatus comprising:
a plurality of plate fins arranged in a circumferential arrangement in the circumferential direction with respect to a central longitudinal axis, wherein plate fins of the plurality of plate fins arranged adjacent to one another in the circumferential direction are sealed by means of a circumferential gap seal.

2. The flame protection apparatus according to claim 1, wherein the flame protection apparatus is in a drying drum.

3. The flame protection apparatus according to claim 2, wherein the drying drum is part of an asphalt facility.

4. The flame protection apparatus according to claim 1, wherein plate fins of the plurality of plate fins arranged adjacent to one another in the circumferential direction have sealing elements that face one another.

5. The flame protection apparatus according to claim 4, wherein the sealing elements that face one another are sealing strips.

6. The flame protection apparatus according to claim 4, wherein the sealing elements are integrally formed as one piece.

7. The flame protection apparatus according to claim 4, wherein the sealing elements are designed as folded edges of the plate fins of the plurality of plate fins.

8. The flame protection apparatus according to claim 1, wherein the plate fins of the plurality of plate fins have a flame protection section that faces the central longitudinal axis and presents a planar surface.

9. The flame protection apparatus according to claim 1, wherein the circumferential arrangement of the plate fins of the plurality of plate fins is configured to be self-supporting.

10. The flame protection apparatus according to claim 1, further comprising at least one plate fin holder fastened to a plate fin of the plurality of plate fins.

11. The flame protection apparatus according to claim 1, wherein a plurality of circumferential arrangements are arranged one behind the other along the central longitudinal axis.

12. The flame protection apparatus according to claim 11, wherein an axial gap seal is formed between plate fins of the plurality of plate fins arranged adjacent to one another along the central longitudinal axis.

13. The flame protection apparatus according to claim 1, wherein the plate fins of the plurality of plate fins have a folded edge at a transverse orientation with respect to the central longitudinal axis.

14. The flame protection apparatus according to claim 1, wherein the plate fins of the plurality of plate fins have a folded edge at a perpendicular orientation with respect to the central longitudinal axis.

15. A plate fin for a flame protection apparatus according to claim 1.

16. A drying drum comprising a flame protection apparatus according to claim 1.
